(19) United States
(12) Patent Application Publication
(10) Pub. No.: US 2017/0200476 A1
(43) Pub. Date: Jul. 13, 2017

(54) SYSTEMS, APPARATUSES AND METHODS FOR FACILITATING ACCESS TO AND DISTRIBUTION OF AUDIOVISUAL FILES BY USE OF MODIFIED AUDIOVISUAL FILES

(71) Applicant: COBAN Technologies, Inc., Houston, TX (US)

(72) Inventors: Allan T. Chen, Sugar Land, TX (US); Terry W. Boykin, Katy, TX (US)

(73) Assignee: COBAN Technologies, Inc., Houston, TX (US)

(21) Appl. No.: 15/467,924

(22) Filed: Mar. 23, 2017

Related U.S. Application Data
(63) Continuation-in-part of application No. 14/715,742, filed on May 19, 2015, now abandoned.
(60) Provisional application No. 62/044,139, filed on Aug. 29, 2014.

(51) Int. Cl. G11B 27/10; H04N 21/2343; H04N 21/258; H04N 5/77; H04N 21/2743; H04N 21/647; H04N 7/18; H04N 21/858; H04N 21/235

(52) U.S. Cl. CPC G11B 27/10; H04N 21/858; H04N 21/23439; H04N 21/25816; H04N 21/2353; H04N 21/2743; H04N 21/64769; H04N 7/185; H04N 5/77

(57) ABSTRACT

Electronic delivery techniques for distribution of audiovisual and associated data files via communication networks. The techniques including conversion of data files to generate modified versions thereof and provision of access to the files and the modified files by designated recipients for limited time periods.

### CROSS-REFERENCE TO RELATED APPLICATIONS

This application is a Continuation-in-Part of, and claims priority to, U.S. patent application Ser. No. 14/715,742, filed May 19, 2015 and entitled “Cloud Information Storage, Access, and Security”, currently pending.

### STATEMENT REGARDING FEDERALLY SPONSORED RESEARCH

Not applicable.

### FIELD OF THE INVENTION

This disclosure relates generally to systems, methods, and apparatuses to assist in managing, communicating, and distributing information including multi-media and/or associated data files. More particularly, but not by way of limitation, this disclosure relates to systems and methods for managing storage, access and distribution of multi-media and/or associated data files under security requirements.

### BACKGROUND

Today's law enforcement agencies are increasing their use of digital data to collect surveillance information and other forms of data to be used as evidence in legal proceedings. Devices and methods for managing multi-media files collected as part of this surveillance and evidence collection are increasing both in number and complexity over time. Multi-media files may be large. As used in law enforcement and other industries that require secure access, multi-media files have traditionally been burned onto Digital Versatile Disks (DVDs) or other high capacity storage medium such that the physical media may be transported to another location in a secure manner.

For example, traditional law-enforcement video solutions typically offer a way to export videos onto optical media such as DVDs and distribute the recorded media to third parties. Third parties typically include other parties to a particular legal proceeding or investigation. Third parties may include the district attorney, defendants, other attorneys, other law enforcement agencies, and so on. For a large agency, creation of optical media may involve expensive equipment (e.g., disc burning and duplication machines) as well as material costs. Technical personnel may also be required to maintain and operate that equipment. Further, once a media is burned into a physical copy, security around access to that physical copy may be a labor-intensive undertaking for law-enforcement employees.

Accordingly, systems and methods for information management, storage, access and distribution as disclosed herein, provide alternatives to previously known methods of providing access to evidentiary information while conforming to special requirements associated with that type of data.

### SUMMARY

According to a first aspect of the invention, a method is disclosed. This embodiment includes converting at least one audiovisual data file to generate a modified version of the at least one audiovisual data file; and sending a notice to at least one recipient via a communication network, wherein the notice includes a link to access the at least one audiovisual data file and/or the modified version of the at least one audiovisual data file.

According to a second aspect of the invention, a system is disclosed. This embodiment includes one or more processors configured to execute instructions to cause the one or more processors to: convert at least one audiovisual data file to generate a modified version of the at least one audiovisual data file; and send at least one recipient a notice via a communication network, wherein the notice includes a link to access the at least one audiovisual data file and/or the modified version of the at least one audiovisual data file.

Other aspects of the embodiments described herein will become apparent from the following description and the accompanying drawings, illustrating the principles of the embodiments by way of example only.

### BRIEF DESCRIPTION OF THE DRAWINGS

It being understood that the figures presented herein should not be deemed to limit or define the subject matter claimed herein, the applicants' disclosure may be understood by reference to the following description taken in conjunction with the accompanying drawings, in which like reference numerals identify like elements.

FIGS. 1A-B illustrate a rear view and a front view, respectively, of a device for capturing (e.g., recording) multi-media and metadata according to some disclosed embodiments.

FIGS. 2A-C illustrates block diagrams of a processing system and two example removable storage devices that may be used for the disclosed integrated mobile surveillance system to capture and store multi-media files and associated metadata according to some disclosed embodiments.

FIG. 3 illustrates a block system diagram showing some additional internal components for the device of FIGS. 1A-B, according to some disclosed embodiments.

FIG. 4 illustrates an intelligent docking, upload, and charging station for recording devices that may interface to cloud accessible storage according to some disclosed embodiments.

FIGS. 5A-B illustrates a possible process flow to upload and manage information via a cloud based storage area as may be used between law enforcement personnel and other related third parties. The illustrated process flow may assist in audit tracking and security requirements of the uploaded information according to some disclosed embodiments.

FIG. 6 illustrates possible data flow and software as a service (SAAS) components for working with information made accessible from cloud based storage according to some disclosed embodiments.

FIG. 7 illustrates an interface showing data export options according to some disclosed embodiments.

FIG. 8 illustrates an export form according to some disclosed embodiments.

FIG. 9 illustrates a recipient communication according to some disclosed embodiments.

FIG. 10 illustrates a screenshot of an audiovisual data file management setup form according to some disclosed embodiments.

FIG. 11 illustrates a screenshot of a file queue management screen according to some disclosed embodiments.

FIG. 12 illustrates a flow chart depicting, at a top level, a method according to some disclosed embodiments.

### NOTATION AND NOMENCLATURE

Certain terms are used throughout the following description and claims to refer to particular system components and configurations. As one skilled in the art will appreciate, the same component may be referred to by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection, or through an indirect connection via other devices and connections.

As used throughout this disclosure the terms “computer device” and “computer system” will both be used to refer to an apparatus that may be used in conjunction with disclosed embodiments of cloud based information, storage, access, and security methods and systems. As used herein, a computer device may be thought of as having a subset of functionalities as compared to a computer system. That is, a computer device may refer to a special purpose processor-based device such as a digital video surveillance system primarily configured for executing a limited number of applications. A computer system may more generally refer to a general-purpose computer such as a laptop, workstation, or server which may be configured by a user to run any number of off the shelf or specially designed software applications. Computer systems and computer devices will generally interact with disclosed methods and systems for cloud information, storage, access and security in the same or similar ways.

The terms “cloud storage” or “cloud based storage” are used interchangeably in this disclosure to describe that data is stored in an area generally accessible across a communication network (which may or may not be the Internet). A “cloud” may refer to a public cloud, private cloud, or combination of a public and private cloud (e.g., hybrid cloud). The term “public cloud” generally refers to a cloud storage area that is maintained by an unrelated third party but still has certain security measures in place to ensure that access is only allowed to authorized users. The term “private cloud” generally refers to a cloud storage area that is maintained by a related entity or that is maintained on separate physical computer resources from any unrelated users.

For simplicity, the terms “multi-media” and “audiovisual” will be used interchangeably throughout this disclosure to refer to files collected (e.g., recorded) by an audio or audio/video recorder. Multi-media or audiovisual data files may include only audio, only video, or audio and video together and the information may be compressed using an industry standard compression technology (e.g., Motion Picture Expert Group (MPEG) standards, Audio Video Interleave (AVI), etc.) or another proprietary compression or storage format. Multi-media or audiovisual files may incorporate associated data files, including metadata files that may be configured in a structured text format such as eXtensible Markup Language (XML).

This disclosure also refers to storage devices and storage drives interchangeably. In general, a storage device/drive represents a medium accessible by a computer to store data and executable instructions. Also, throughout this disclosure reference will be made to “plugging in” a storage drive. It is noted that “plugging in” a storage drive is just one way to connect a storage drive to a computer device/system. This disclosure is not intended to be limited to drives that physically “plug in” and disclosed embodiments are also applicable to devices that are “connected” to a computer device or computer system. For example, devices may be connected by using a cable or by connecting using a computer bus. Additionally, references to “removable” storage are analogous to plugging-in/unplugging a device, connecting/disconnecting cabled access to a device, and/or establishing/disconnecting networked access to a device or storage area on a network (either wired or wireless).

As used herein, the term “evidentiary requirements” refers to one or more requirements required for data collected that may later be used as evidence in a legal proceeding. These requirements are discussed throughout this disclosure and include: chain of custody of evidence, access controls, audit functions, retention policies, and the like. The term “evidentiary controls” refers to controlling at least some of the discussed evidentiary requirements.

The term “metadata” refers to information associated with the recording of audio data, video data, or audio and video data together, or information included in the recording of such data, and metadata may contain information describing attributes associated with one or more acts of actual recording of audio, video, or audio/video data. That is, the metadata may describe who (e.g., officer ID) or what (e.g., manual or automatic trigger) initiated or performed the recording. The metadata may also describe where the recording was made. For example, location may be obtained using global positioning system (GPS) information. The metadata may also describe why the recording was made (e.g., event tag describing the nature of the subject matter recorded). The metadata may also describe when the recording was made, using timestamp information obtained in association with GPS information or from an internal clock, for example. Metadata may also include information relating to the device(s) used to capture or process information (e.g. a unit serial number, mac address, etc.). Metadata may also include telemetry or other types of data. From these types of metadata, circumstances that prompted the recording may be inferred and may provide additional information about the recorded information. This metadata may include useful information to correlate recordings from multiple distinct recording systems. This type of correlation information may assist in many different functions (e.g., query, data retention, chain of custody, precise synchronization and so on).

### DETAILED DESCRIPTION OF DISCLOSED EMBODIMENTS

While various embodiments are described herein, it should be appreciated that the present disclosure encompasses many inventive concepts that may be embodied in a wide variety of contexts. Thus, the following detailed description of exemplary embodiments, read in conjunction with the accompanying drawings, is merely illustrative and is not to be taken as limiting the scope of this disclosure. Rather, the scope of the invention is defined by the appended claims and equivalents thereof.

Illustrative embodiments of this disclosure are described below. In the interest of clarity, not all features of an actual implementation are described for every embodiment disclosed in this specification. In the development of any such actual embodiment, numerous implementation-specific decisions must be made to achieve the design-specific goals, which will vary from one implementation to another. It will be appreciated that such a development effort, while possibly complex and time-consuming, would nevertheless be a routine undertaking for persons of ordinary skill in the art having the benefit of this disclosure.

Embodiments of the present disclosure provide for management and “virtual” sending of multi-media files and/or associated data files stored in cloud based storage, a local or remote server, or a hybrid combination of cloud and local/remote server storage. Virtual sending refers to sending of a link, such as a hyperlink, to assist in accessing the remotely stored information rather than sending actual files themselves. In some embodiments, the data shared relates to data that might be collected by one or more, mobile surveillance systems, portable video recording devices, and other types of data recorders. The mobile (and possibly stationary) surveillance system devices may be configured to capture video, audio, and data parameters pertaining to activity in the vicinity of the surveillance system, for example a police vehicle. Other type of vehicles and other situations requiring a surveillance unit are also within the scope of this disclosure. Other types of vehicles may include, but are not limited to, any transportation means equipped with a mobile surveillance system (e.g., civilian transport trucks). The disclosed embodiments are explained in the context of mobile surveillance systems that aid in law enforcement such as busses, ambulances, police motorcycles or bicycles, fire trucks, airplanes, boats, military vehicles, and so on. However, in some embodiments, data collected from other types of vehicles including non-law-enforcement vehicles may be collected and managed in cloud based storage as required by that different industry.

Mobile surveillance systems have been in use by police departments for the past few decades. Over that period of time, several advances have been introduced in the technology used to provide video/audio and data regarding specific police events. In the late 1990s through the early 2000s, digital technologies became prevalent in the industry, replacing existing analog technologies. With the use of digital technologies, law enforcement agencies obtained several advances over previous technologies and may further benefit from additional advances (e.g., as described in this disclosure). In general, digital technologies are more adaptable and offer more opportunities for improvement than corresponding analog technologies. This is largely because digital video/audio files may be processed in a multitude of ways by specifically configured computer devices. This disclosure elaborates on several novel techniques to enhance the capability, reliability, ease of use, security, integrity, and other aspects of mobile surveillance systems and the information they collect.

Today, there are numerous surveillance systems in use by law enforcement and the data they collect continues to increase in volume and complexity. Accordingly, enhanced management and distribution techniques for the amount of available data may be required. That is, vast amounts of data may need to be collected and controlled with conformance to “evidentiary requirements” as discussed herein. Additionally, there is a need to improve data access and distribution, integrity, reliability, and security throughout the lifecycle of that data. Legal requirements for data collected by a remote/mobile surveillance system include conformance to judiciary requirements such as “chain of custody/evidence,” and “preservation of evidence.” Chain of custody (CoC), in legal contexts, refers to the chronological documentation or paper trail audit, showing the seizure, custody, control, transfer, analysis, and disposition of physical or electronic evidence. Preservation of evidence is a closely related concept that refers to maintaining and securing evidence from a particular crime scene before it ultimately appears in a courtroom. For example, the evidence may go to a forensic laboratory prior to arriving at the courtroom. Evidence admissibility in court is predicated upon an unbroken chain of custody. It is important to demonstrate that the evidence introduced at trial is the same evidence collected at the crime scene [e.g. that is, all access to the evidence (e.g., electronic files) was controlled and documented], and that the evidence was not altered in any way. Requirements for law enforcement are further described in “Criminal Justice Information Services (CJIS) Security Policy,” version 5.3 published Aug. 4, 2014 referenced as “CJISD-ITS-DOC-08140-5.3” which is hereby incorporated by reference in its entirety.

As will be recognized, disclosed embodiments may allow for comprehensive back-office video management software to be provided using a software as a service (SAAS) architecture, giving each agency (even small remote agencies) the tools they need to capture, transfer, store and manage their digital video evidence from car to court. That is, the disclosed system and back-office management techniques meet the preservation of evidence requirements outlined above with respect to management of digital evidence for law enforcement. All activity with respect to digital evidence in the back-office system may be logged to ensure proper documentation of evidence handling. The disclosed systems and techniques may include electronic transfer of evidence in a controlled manner and may provide comprehensive coordination of potential evidence captured from a plurality of surveillance systems. While the focus of this disclosure relates to maintenance, distribution, and access to collected data, the disclosed techniques may also include integrated DVD burning software at different points in the evidence maintenance lifecycle as a means of evidence transfer to work in conjunction with cloud based maintenance and “virtual” transfer.

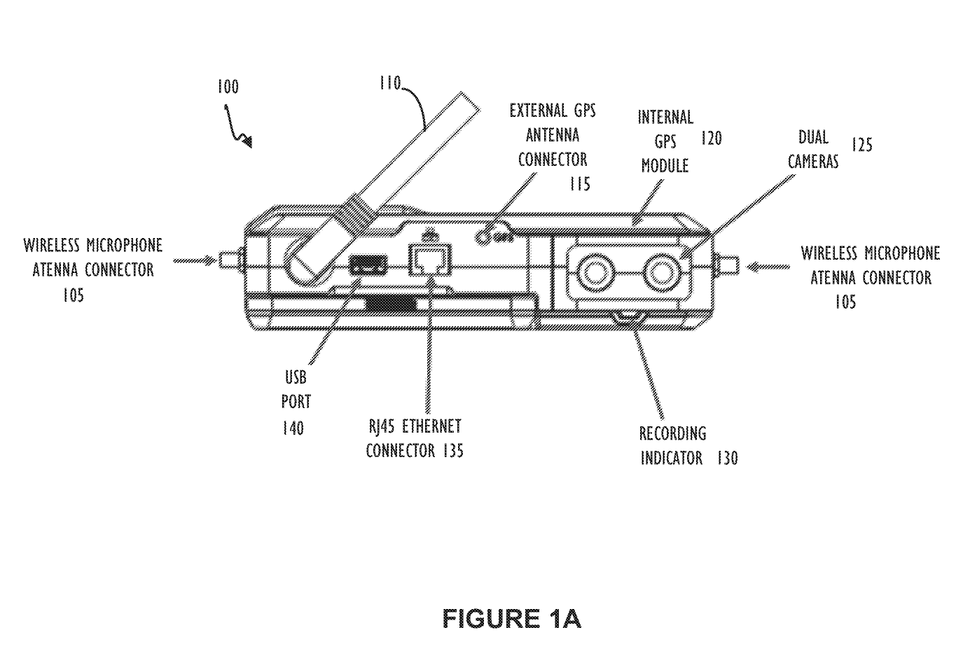

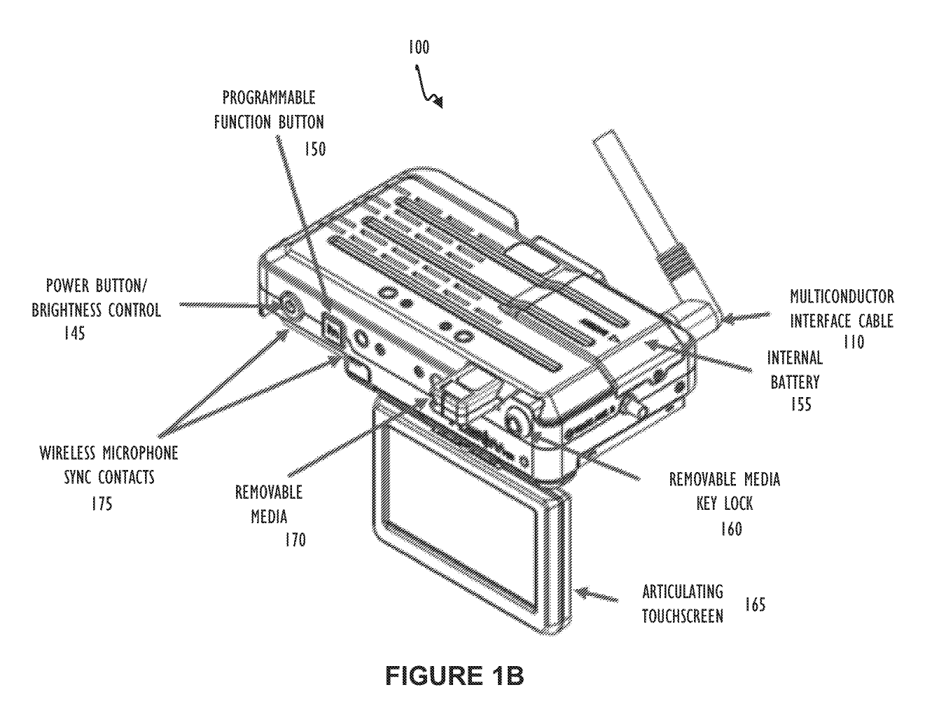

Referring now to FIGS. 1A-B, disclosed embodiments of an integrated mobile surveillance system 100 are intended to incorporate a plurality of functions as being “built-in” to mobile surveillance system 100. Additionally, aspects of integrated mobile surveillance system 100 have been designed with consideration for future expansion as new technologies and capabilities become available. Aspects of integrated system 100 include, but are not limited to, the following integrated functional units. Integrated system 100 may be configured to have one or more than one of each of these functional units, as appropriate. Integrated wireless microphone receivers 105 to allow capture of audio from a remote wireless microphone located within proximity of integrated system 100. An external multi-conductor interface cable 110 to allow a wired connection to one or more internal interfaces of integrated system 100. Universal serial bus (USB) port(s) 140 for general peripheral connectivity and expansion. An integrated global positioning system (GPS) module 120 with optional external antenna or connector 115 to be used in part for capturing location data, time sync, speed logging. The GPS information may also be used for time synchronization and to coordinate data, ultimately facilitating map based search and synchronization (e.g., locate recorded information from a time and/or location across a plurality of recording devices). Dual front facing cameras 125 may include both a wide-angle video camera and a tight field of view camera for optical zoom effect snap shots. A record indicator 130 provides an indication of a current operating mode for integrated system 100. A wired Ethernet adapter (e.g., Gigabit, 10/100 BASE-T, etc.) 135 (or a wireless network adapter, not shown) for data upload, computer interface, remote display and configuration. Additionally, multiple wireless data communication devices (not shown) may be integrated for flexibility and expansion. For example, the system may include adapters conforming to wireless communication specifications and technologies such as, 802.11, Bluetooth®, radio-frequency identification (RFID), and near field communication (NFC). Each of these interfaces may be used, at least in part, for data exchange, device authentication, and device control. A serial port (not shown) may be used to interface with radar/laser speed detection devices and other devices as needed. A G-Sensor/Accelerometer (not shown) may be used for impact detection and to automatically initiate record mode. The G-Sensor/Accelerometer may also provide data logging for impact statistics and road condition data. A DIO (Digital Input/Output) (not shown) that may be used for external triggers to activate record mode and/or provide metadata to the system. The DIO may also be used to control external relays or other devices as appropriate. The DIO may also be used to detect brake, light bar, car door, and gun lock so that the video recording may be automatically triggered. As shown in FIG. 1B, a combination power button and brightness control 145 may be used to turn on the system and control the brightness of the monitor after the system is turned on. Programmable function button 150 provides a user definable external button for easy access to instigate any function provided by integrated system 100. For example, rather than traversing through a set of menus on articulating touch screen 165, a user may define function button 150 to perform an action with one touch (e.g., instant replay, event tagging of a particular type, etc.). An articulating touch screen 165 that may be used to view video in real-time, or in one or more play back modes. Touch screen 165 may also serve as an input mechanism, providing a user interface to integrated system 100. An integrated speaker (not shown) may be used for in-car audio monitoring and in-car video/audio file playback. An integrated internal battery 155 for proper shutdown in the event of sudden power loss from the vehicle that might occur as a result of a crash, for example, is shown. Also depicted is a removable media 170 that in accordance with some embodiments may be an SSD Flash drive (e.g., secure digital (SD) or universal serial bus (USB) type), including any type of storage that may be inserted or attached to the system via a storage interface (e.g., SCSI, SATA, etc.). For security of access to data, removable SSD flash drive 170 may be secured via a mechanical removable media key lock 160. In some embodiments, event based data is recorded and written to the removable drive to be transferred to a back-office server and/or cloud repository for storage and management. Wireless microphone sync contacts 175 may be configured to synchronize a wireless microphone/camera, such as a body worn camera and microphone, for communication with integrated system 100. In addition to actual sync contacts, that require physical contact, other synchronization methods for wireless microphone/cameras include utilizing NFC or RFID capability between the wireless device and integrated system 100.

In addition to the components mentioned above, disclosed embodiments of integrated mobile surveillance system 100 may be configured to include functional components to provide operational characteristics that may include the following. A pre-event playback function which may be used to tag historical events. Recall, normal operation may be to record continuously to internal storage and to store tagged information (e.g., marked for export) to removable storage. However, in order to cover the case in which an incident occurred without a timely event trigger, the operator may instruct the system to navigate back to an earlier time captured in the internal storage and play back that video/audio information. The selected historical video, at any available point in time, may be marked, tagged for extraction, and stored to removable storage, as if the event had been tagged at that historical time. Another functional component may provide an instant replay function configured to playback the last predetermined amount of time with one button press. Note that both the instant replay and pre-event playback (along with general system operation) allow for simultaneous playback while the system is concurrently recording information. Pre-defined event tags and a pre-defined event tagging functions may also be provided. For example, tags may include DWI, felony, speeding, stop sign, chase, etc. The tagging action may be used to catalog portions of recorded data. For example, after an event is cleared, such as stop recording, an option to select a predefined event may be displayed. Upon selection, the system may allow an associated portion of collected information to be marked in a text file for current and future identification and storage. Further, when the tagged information is transferred to the data management software, the tagged information may be searched by event type and maintained on the server or in the cloud with the proper retention period as appropriate—based on the defined event type. A streaming function may also be provided to stream live view and recorded video, audio, and/or data over available wireless and wired networks. The integrated system 100 may also integrate “hotspot” capabilities which allow the system to serve as an agency accessible, mobile wireless local area network (WLAN).

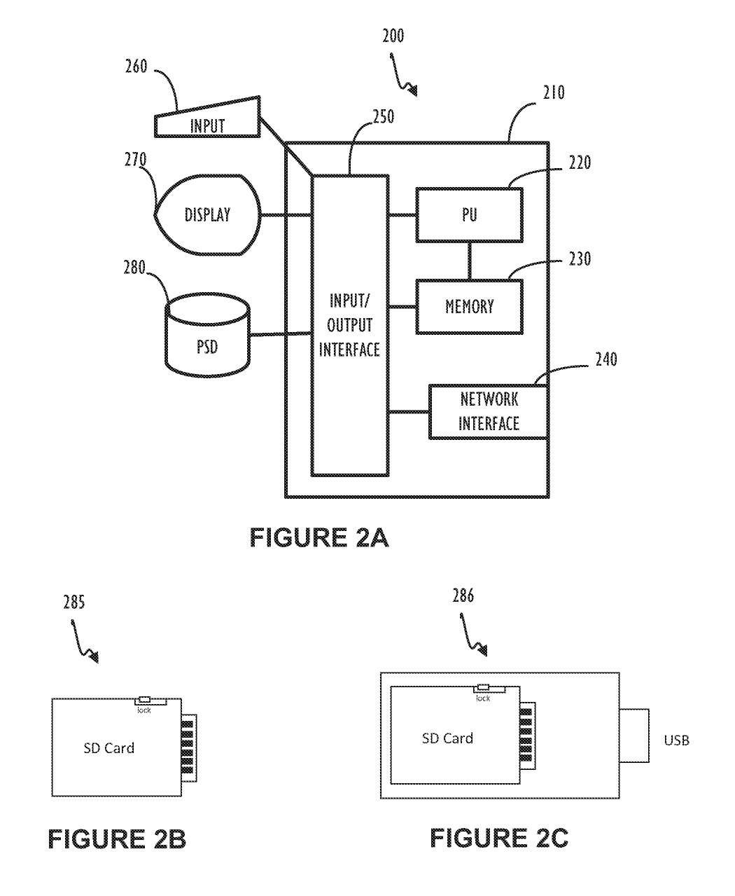

Referring now to FIGS. 2A-C, possible internals and peripheral components of an example device 200, which may be used to practice the disclosed functional capabilities of an integrated surveillance system such as system 100, are shown. Example device 200 comprises a programmable control device 210 which may be optionally connected to input device 260 (e.g., keyboard, mouse, touch screen, etc.), display 270 or Program Storage Device (PSD) 280. Also, included with programmable control device 210 is a network interface 240 for communication via a communication network with other computers and infrastructure devices (not shown). Note network interface 240 may be included within programmable control device 210 or be external to programmable control device 210. In either case, programmable control device 210 may be communicatively coupled to network interface 240. Also, note PSD 280 represents any form of non-volatile storage including, but not limited to, all forms of optical and magnetic storage elements including solid-state storage.

Program control device 210 may be included in a device 200 and be programmed to perform techniques including cloud based storage of data and/or associated multi-media files, in accordance with this disclosure. Program control device 210 comprises a processor unit (PU) 220, input-output (I/O) interface 250 and memory 230. Processing unit (PU) 220 may include any programmable controller device including, for example, the Intel Core®, Pentium® and Celeron® processor families from Intel and the Cortex ARM processor families from ARM® (INTEL® CORE®, PENTIUM® and CELERON® are registered trademarks of the Intel Corporation. CORTEX® is a registered trademark of the ARM Limited Corporation. ARM® is a registered trademark of the ARM Limited Company). Memory 230 may include one or more memory modules and comprise random access memory (RAM), read only memory (ROM), programmable read only memory (PROM), programmable read-write memory, and solid state memory. One of ordinary skill in the art will also recognize that PU 220 may also include some internal memory including, for example, cache memory.

Various changes in the materials, components, circuit elements, as well as in the details of the illustrated systems, devices and below described operational methods are possible without departing from the scope of the claims herein. For instance, acts in accordance with disclosed functional capabilities may be performed by a programmable control device executing instructions organized into one or more modules (comprised of computer program code or instructions). A programmable control device may be a single computer processor (e.g., PU 220), a plurality of computer processors coupled by a communications link or one or more special purpose processors (e.g., a digital signal processor or DSP). Such a programmable control device may be one element in a larger data processing system such as a general-purpose computer system. Storage media, as embodied in storage devices such as PSD 280 and memory internal to program control device 210 are suitable for tangibly embodying computer program instructions. Storage media may include, but not be limited to: magnetic disks (fixed, floppy, and removable) and tape; optical media such as CD-ROMs and Digital Versatile Disks (DVDs); and semiconductor memory devices such as Electrically Programmable Read-Only Memory (EPROM), Electrically Erasable Programmable Read-Only Memory (EEPROM), Programmable Gate Arrays and flash devices. These types of storage media are also sometimes referred to as computer readable medium or program storage devices.

FIG. 2B illustrates a secure digital (SD) card that may be configured as the removable storage device described above. An SD card is a nonvolatile memory card format for use in portable devices, such as mobile phones, digital cameras, handheld consoles, and tablet computers, etc. An SD card may be inserted into a receptacle on the device conforming to the SD specification or may alternately be configured with an interface to allow plugging into a standard USB port (or other port). An example of the adapter for USB compatibility is illustrated in FIG. 2C. Modern computer operating systems are typically configured to automatically permit access to an SD card when it is plugged into an active computer system (sometimes referred to as plug-n-play). In computing, a plug and play device or computer bus is one with a specification that provides for or facilitates the discovery of a hardware component in a system without the need for physical device configuration or user intervention in resolving resource conflicts. Because of additional security requirements regarding data access with respect to the law enforcement field, disclosed systems may incorporate a specifically modified interface to the removable storage drive utilized in device 100 (i.e., removable media 170). Modifications permitting specialized access to removable media, such as a secure storage drive, are described in co-pending U.S. patent application Ser. No. 14/588,139, entitled “Hidden Plug-in Storage Drive for Data Integrity,” by Hung C. Chang, which is incorporated by reference herein. Modifications permitting specialized functionality from removable media are described in co-pending U.S. patent application Ser. No. 14/593,722, entitled “Self-contained Storage Device for Self-contained Application Execution,” by Allan Chen et al., which is incorporated by reference herein. Modifications permitting enhanced storage and upload models are described in co-pending U.S. patent application Ser. No. 14/686,192, entitled “Shared Server Methods and Systems for Information, Storage, Access, and Security,” by Allan Chen et al., which is incorporated by reference herein.

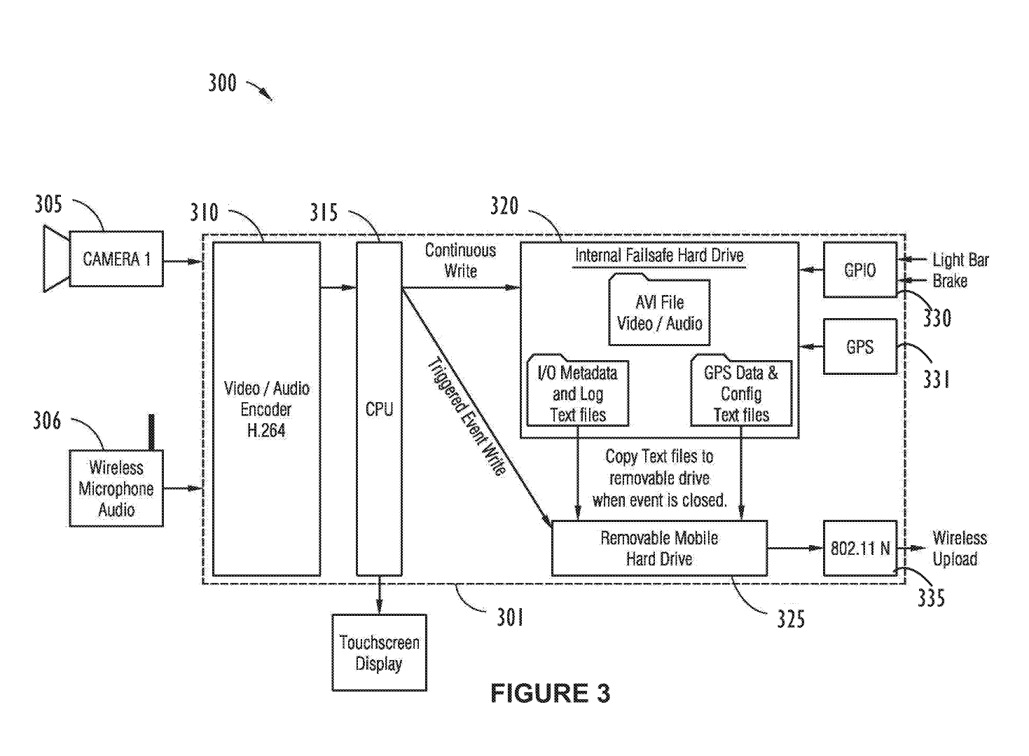

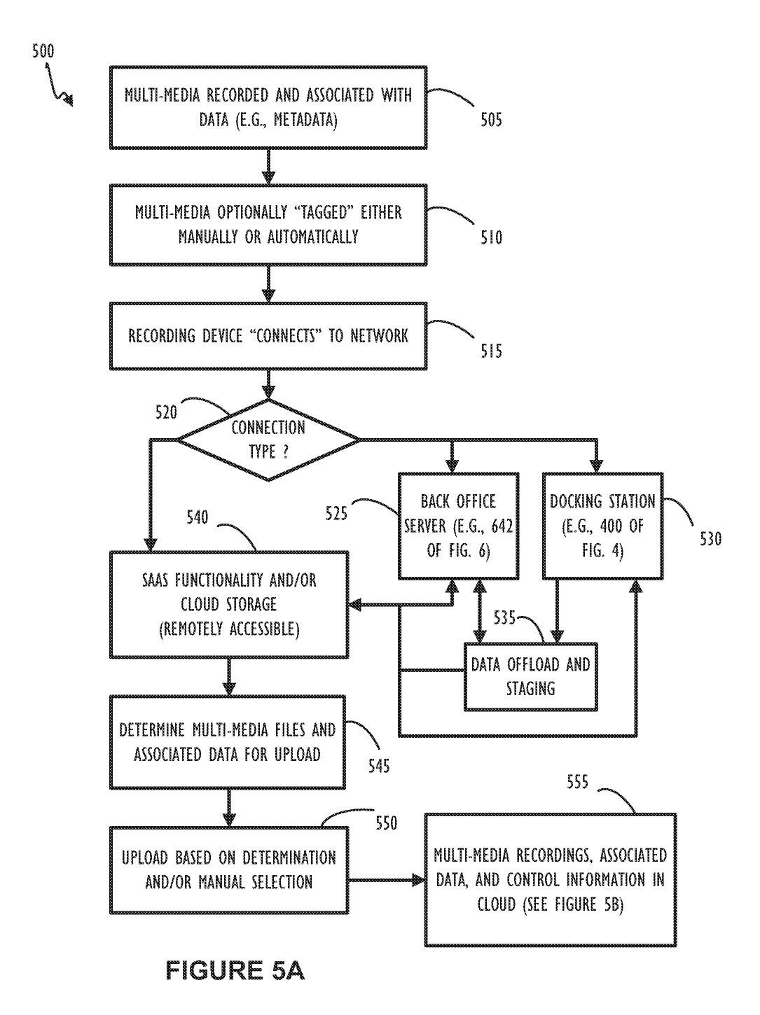

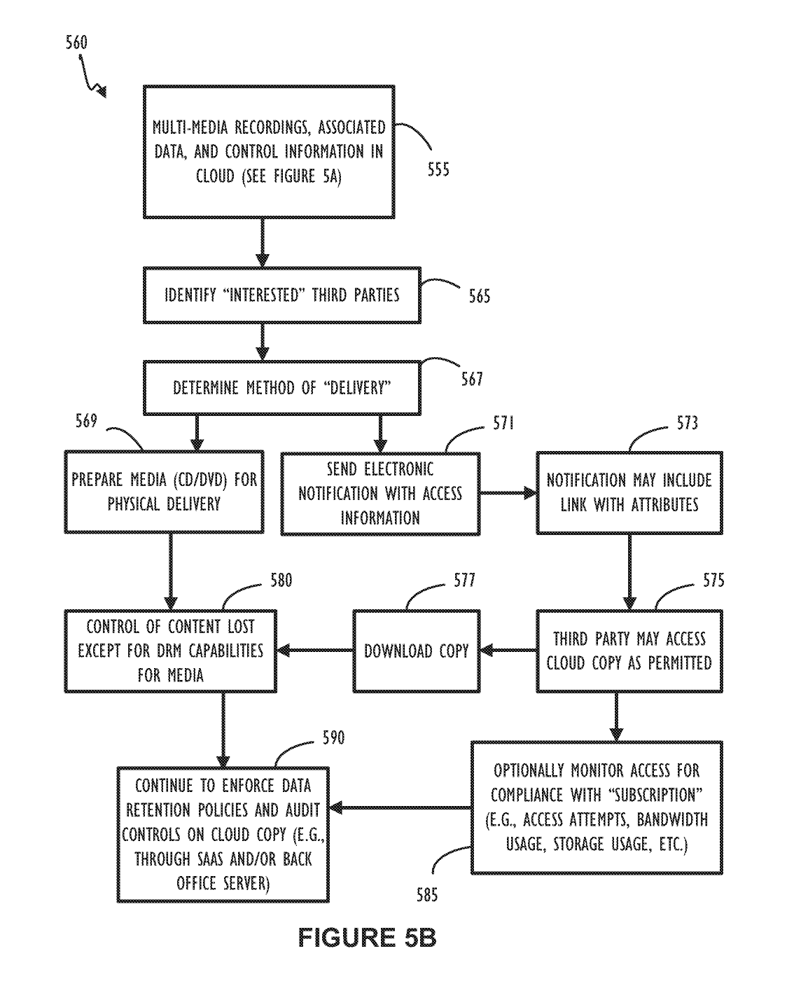

Referring now to FIG. 3, block diagram 300 illustrates one embodiment of an integrated audio-video-data surveillance system. Note that each of the components shown in block diagram 300 may be communicatively coupled to other components via communication channels (e.g., bus) not shown in the block diagram. The flow arrows of block diagram 300 are very general in nature. In use, video and audio may be captured by camera 305 and microphone 306 respectively. Captured data may be provided initially to video/audio encoder 310 to encode and optionally compress the raw video data and the encoded data may be stored in a memory area (not shown) for access by CPU 315. Encoded data may also be selectively stored to either internal failsafe hard drive 320 or removable mobile hard drive 325 individually or to both simultaneously. Data may also be transferred, for example at the direction of a user, from internal failsafe hard drive 320 to removable mobile hard drive 325. Data capture devices such as general purpose input output (GPIO) 330 and GPS 331 may be used to capture metadata to associate with captured surveillance information (e.g., multi-media files). All pertinent captured metadata may be associated with captured video/audio recordings using structured text files such as, for example, eXtensible Markup Language (XML) files. In addition to captured metrics provided by real-time capture inputs, XML files may be utilized to store many different types of metadata associated with captured video and data. This collection of metadata may be used to provide enhanced security and auditing functions associated with the surveillance information (e.g., multi-media recordings). That is, the metadata may describe, when, where, who, and why information was accessed, among other things, in addition to indentifying security parameters for access to the surveillance information. The metadata may include, but not be limited to, timestamps of capture, [internal clock (not shown) of system 100 may be synchronized using GPS data] event tags, GPS coordinates, GPS and RADAR/LIDAR measurement from a target vehicle, breathalyzer analysis information, analytical information, and so on. Wireless interface 335 (or a wired interface (not shown) when available) may be used to upload information from one or more surveillance systems to back office servers located, for example, at a police station or to cloud based resources. Back office servers and cloud based resources will be discussed in more detail below with reference to FIGS. 5A-B and 6.

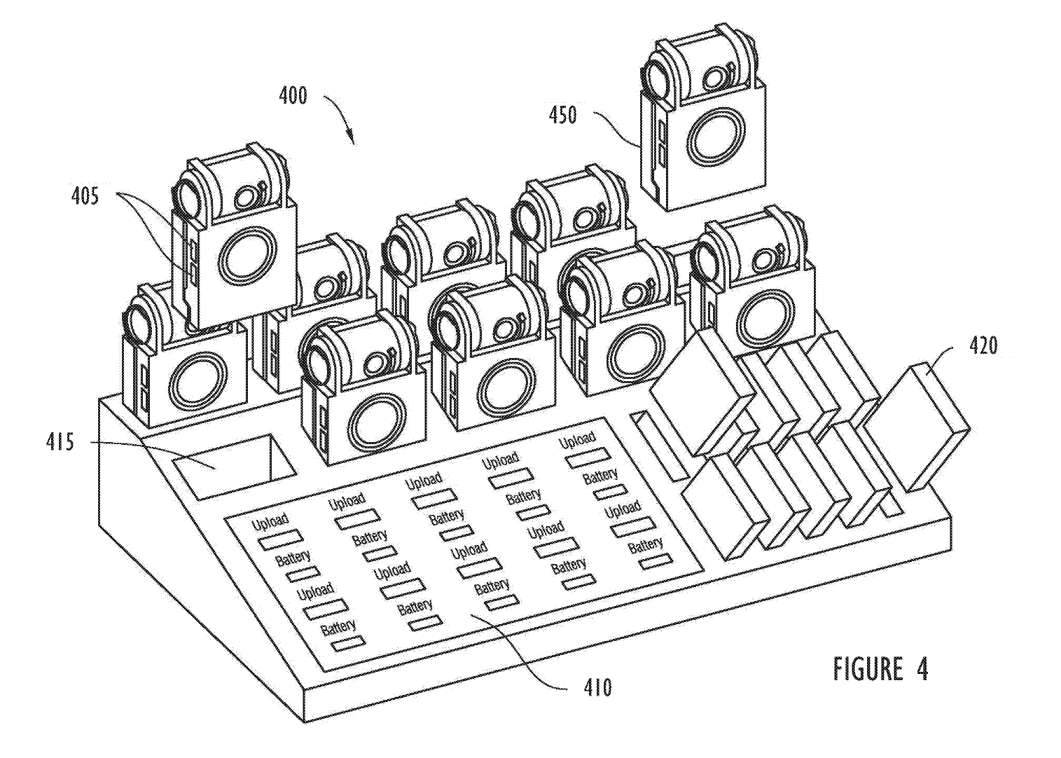

Referring now to FIG. 4, advanced docking station 400 may provide additional benefits for users that maintain a plurality of portable body worn cameras 450 and/or a plurality of surveillance systems. Docking station 400 may also perform different aspects of the cloud upload process described below in FIGS. 5A-B. Some or all portable body worn cameras 450 may incorporate one or more programmable function buttons 405. As shown in FIG. 4, docking station 400 may have multiple ports/cradles 415. Docking station 400 may assist in data upload, device checkout, device upgrade (e.g., firmware/software update), recharging of battery packs 420 and other maintenance type functions that may be performed, for example, at a police station. For clarity, not all repeated elements in FIG. 4 have an associated reference number. Embodiments of the disclosed docking station may support maintenance functions for multiple portable devices such as body worn cameras 450 concurrently. The disclosed docking station 400 may be multifunctional for uploading and/or downloading of video/audio and associated metadata. Configuration data such as unit ID, user ID, operational modes, updates, and so on, may be maintained and versions of such configuration information may be presented on display screen 410 (which may also be a touch screen interface to docking station 400).

Docking station 400 may have integrated interfaces to different types of surveillance systems. Interfaces such as, USB, wired Ethernet or wireless network, as well as interface ports for battery charging may be included. Docking station 400 may also contain: a CPU and be configured as a computer device (see FIG. 2) with optional integrated touch screen display 410, output connectors (not shown) for an optional external display/mouse or device expansion. Docking station 400 may have an option for a wireless display (not shown) to be used for status indication as well as for user interface capabilities. Docking station 400 may include wireless communications such as Bluetooth and/or 802.4AC/AD. Docking station 400 may also be configured to work as an Access Point for a wireless communication network or may be configured to act as a bridge to allow portable client devices to access functionality of docking station 400 and possibly connect to other system components including local or cloud based servers. Docking station 400 may also include functional software or firmware modules to support automatic upload to cloud based storage based on different criteria associated with multi-media and/or data files. Upload to cloud based storage is discussed in more detail below with reference to FIGS. 5A-B and 6.

Docking station 400 may also have an internal storage device to facilitate fast off-load storage which may be used to facilitate a download/forward process for audio/video and metadata captured on a surveillance system device (e.g. the body worn camera 450). For example, the user may place the body worn camera 450 into a docking station cradle 415 and docking station 400 offloads the data to the local onboard storage drive (not shown) which may immediately (or based on a timer) upload that information, or a portion thereof, to a server (e.g., back office server or cloud storage). Uploads may be prioritized based on many different attributes such as time, size, event type priority, and so on. Docking station 400 may also have an integrated locking mechanism for one or more of the uploading/charging ports/cradles 415. The docking station 400 may be configured to control the locking mechanism to hold or release the wearable device in order to prevent the user from taking it out during uploading/downloading, or to make sure that only the recently “checked out” device is removed, for example.

The touch screen display 410 of FIG. 4 illustrates one possible graphical user interface (GUI) layout as an example only. Actual layouts may contain more information and features and may be configurable based on requirements of different end users. In FIG. 4, the GUI shows examples of upload status and battery charging progress. Other screens may be available on the GUI display 410 to provide other status information such as unit ID, user ID, and/or to assist with initiating upload to cloud based storage.

Having the above understanding of how multi-media files and associated metadata may be collected, we now turn to a discussion of a cloud based storage model for securing and auditing access to recorded information. The cloud based storage model may be beneficial for both small and large law-enforcement agencies as well as other industries.

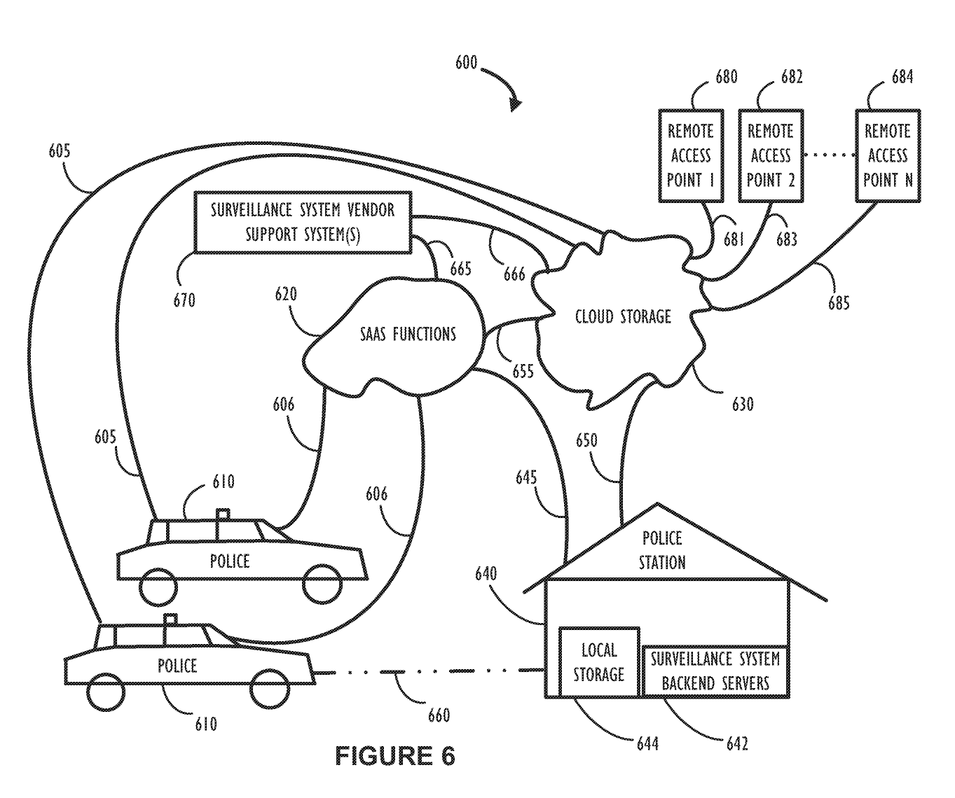

Referring now to FIGS. 5A-B, process flow 500 and its continuation process flow 560 illustrate a possible method for uploading information to cloud based storage for access or distribution to interested third parties. The process flows 500, 560 may also assist law enforcement personnel with compliance to chain of custody of evidence requirements for legal evidence and other required maintenance functions as explained further below. In this example, overall process flow, the recording device may for example be mobile surveillance system 100 or body worn camera 450, the docking station may be docking station 400 described above, and the back-office servers may be the back-office servers 642 of FIG. 6 described below. For clarity of reading, these specific examples and their reference numbers will not be repeated throughout the discussion. Also, note that docking station 400 is an example embodiment of computer device including a programmable control device (See FIG. 2) described above while back office servers 642 may be more accurately thought of as computer systems (a superset of computer devices as used herein).

Beginning at block 505, video recorded and its associated metadata are identified. This may happen during a patrol shift, or may happen at the end of a patrol shift. For example, as the officer performs his shift duties (e.g., goes on patrol, etc.), a recording device may record and store evidence and surveillance data onto the storage device of the recording device. During the shift, all data recorded on the storage device may be associated with the officer for audit tracking purposes and a metadata file may be used to “tag” or “mark” any recorded data with any number of pertinent attributes such as, officer's ID, event type, date/time, GPS location, etc. This “tagging” may happen automatically or manually as discussed above and shown at block 510. Next, at block 515 the recording device may connect to a communication network using one of many different connection types. Different types of connections may be available during a patrol shift (e.g., broadband, satellite link, and so on) or at the end of a patrol shift (e.g., WiFi, Bluetooth, broadband, satellite link, Ethernet, and so on). For simplicity, only a few specific examples are described here, but others would be apparent to those of ordinary skill in the art, given the benefit of this disclosure. At block 520, based on a) the connection type and b) what other system/device the recording device has established a connection to, different process flow options are shown in FIG. 5A as a non-exhaustive set of examples. Block 525 represents that the recording device has connected to a back-office server. Block 530 represents that the recording device or possibly only its removable storage media has connected to a docking station. Also, as illustrated, it is possible to have a direct connection type from the recording device directly to SAAS and/or cloud storage as illustrated by block 540. As illustrated in FIG. 5A, the communication flows between the back-office server and SAAS and/or cloud storage (i.e., block 525 and block 540) may be bidirectional. The communication flow between the back-office server and the data offload and staging area (i.e., block 525 and block 535) may be bidirectional. The communication flow between docking station and SAAS and/or cloud storage may be bidirectional (i.e., block 530 and block 540). Each of these bi-directional links may be used to facilitate coordinated decision making regarding what information to upload/download/delete based on a) status of completion of transfer or b) retention criteria information (among other possibilities). Thus, coordinated decision making may take place across the different processing systems utilized to implement the overall methods of this disclosure.

After a connection is established (as shown at block 525) between the recording device and one or more back office servers, the functionality of the one or more back office servers may interact with the recording device and either perform data offload and staging functions (block 535) and/or communicate directly with SAAS functionality and/or cloud storage (block 540). Of course, the back-office servers may perform different offload functions based on the attributes of the multi-media files (e.g., metadata tags). For example, the back-office servers may transmit some multi-media files with their associated metadata directly to the cloud storage while offloading others to a local offload storage area. Some multi-media files and their associated metadata files may be both staged locally and sent to the cloud concurrently. Many different options are available. Options discussed here are only to be considered non-limiting examples. Similarly, block 530 indicates a connection has been established with a docking station such as docking station 400. As explained above, some embodiments of a docking station may include functionality to automatically offload and stage data via the docking station itself and upload to cloud storage (block 540). Additionally, like the back-office servers, a docking station may, in some embodiments, communicate directly with SAAS and/or cloud storage (block 540). Although not explicitly shown in FIG. 5A, data offload and staging area may be internal to either or both of a docking station or back office servers and they may each be configured to access the other's internal area either directly or indirectly (e.g., via proxy connection). In any case, multi-media files and their associated data files are processed to determine which multi-media files and data to upload as shown at block 545. The determination may be unilaterally made by any one of the above mentioned functional units (e.g., recording device, back-office server, docking station, and SAAS functionality) or may be made in a coordinated fashion by one or more of the above mentioned functional units working together. As shown at block 550, after a determination is made, the multi-media files and associate metadata may be uploaded. Additional multi-media files and associated metadata may also be uploaded based on manual selection. Finally, block 555 indicates that recordings, associated data (e.g., metadata), and possibly additional control information is available in cloud storage.

Continuing on with FIG. 5B, process flow 560 begins at block 555 when the multi-media recordings and associated information is available in cloud storage. At block 565, interested third parties may be identified based on criteria associated with one or more of the uploaded multi-media recordings. After identification, a method of “delivery” to the identified third party may be determined at block 567. In this example, “delivery” may be either physical delivery or virtual delivery (e.g., via a communication network link). Block 569 represents a physical delivery method where a copy of data uploaded to the cloud storage and accessible to the SAAS functionality may be put onto a media, such as Compact Disk (CD) or Digital Versatile Disk (DVD), for physical transfer to the interested third party. As indicated in block 580, once a physical copy has been extracted from a cloud storage area, the SAAS and other control over the multi-media recordings is “lost.” That is, the cloud functionality will no longer have control because the multi-media recordings have been extracted from it. Techniques to prevent and/or control access to the content of the physical media may be implemented through encryption or other types of Digital Rights Management (DRM) capabilities. An alternative to physical delivery and the “loss” of control would be to maintain control of the multi-media files in the cloud and send electronic notification and access information as illustrated in block 571. Flow would then continue to block 573 where a notification may be prepared containing a link (e.g., hyperlink, URL, URI, etc.) to the appropriate multi-media recording(s) for the identified third party. The link may further be embedded with information to convey to the interested third party information about the multi-media recording and/or its access restrictions. For example, the link may indicate that password security or possibly biometric security may be required to access the content pointed to by the link. The link may further inform the recipient of the type of access they have (e.g., review only, download, delete, etc.) and/or provide an indication of expiration date by which to access the content of the link. At block 575, the third party may access the cloud based copy of the multi-media while it is still under the control of the cloud based functionality (e.g., SAAS and cloud storage). Block 577 indicates that some users may be permitted to download a copy of the information. As indicated by the flow to 580 for this case, once downloaded, some control capability may be lost as explained above. Block 585 indicates that third parties may be optionally monitored for compliance with subscription criteria enforced by the SAAS or cloud based functionality. For example, a third party may be monitored for access attempts, bandwidth usage, storage usage, or other criteria that may be set out based on a level of subscription they are paying for with regards to the service. Finally, block 590 indicates that while data is maintained on the cloud storage, the SAAS or cloud functionality may continue to enforce and monitor data retention policies, audit controls, and so on.

Having an understanding of the above discussed data flows 500 and 560, it will be understood that one example embodiment may include a remote application and database server that may be hosted by a software as a service (SAAS) cloud application to reduce (or eliminate) the need to hire additional computer technicians. Some disclosed embodiments may be implemented in a hybrid cloud and provide local (on site) data storage for portions of data that require high bandwidth across a communication network (e.g., Internet, police network) while maintaining metadata in the cloud. This configuration may help ensure security and integrity of digital evidentiary data by maintaining a single global copy of metadata in the cloud (for storage) while still allowing fast local access speeds for review of potentially large video/audio files. Also, optionally, data on a shared server may be downloaded to the local data storage site as backup data and then re-uploaded to a remote (or cloud based) site if there is a systems failure or “intrusion” attack at the remote (or cloud based site).

To eliminate the need for (or to augment) a conventional DVD burner based system, the user may auto upload all data and metadata to the cloud. Optionally, a user may provide (or user event tags may be used as) identification criteria for certain types of videos (and their metadata) to be sent to the cloud automatically as soon as the videos are uploaded to a server (or staged on docking station 400) with certain “event type” metadata. For example, an administrator may define: all Driving under the Influence (DUI) videos are sent to cloud based storage and 2 DVD copies are burned. When an officer tags a video as a DUI event type, as soon as the video is uploaded to the cloud, the video may also be sent to a DVD burner for 2 copies automatically. Alternatively, rather than burning DVD copies, an email may be automatically generated and sent or instructions may be provided to an employee to create and send an email. The email may include a time limited access link to personnel or third parties (e.g., prosecuting attorney) that may have an interest in the DUI event. Based on the tag type assigned, a wide number of triggers and follow-on responses may be generated automatically. Furthermore, actions relating to compliance with record retention policies may be automatically generated so that as specific retention periods pass, records are automatically deleted. Thus, the user may readily and easily take advantage of cloud-based storage for an almost limitless cataloguing and archiving device.

Referring now to FIG. 6, data flow in a content management system that may utilize the disclosed SAAS functionality and cloud storage is illustrated in block diagram 600. The SAAS component (including SAAS functions 620) may be a system which typically includes a web-based portal that is the entry point to the software services for all users requiring data access. As with other data access points, access may be controlled by authentication means such as, but not limited to, passwords, fingerprints, encryption, and so on. Authorized users may access specific content utilizing a “link” as described above in the discussion of FIG. 5B. In most cases a user will interact with a cloud based copy of the multi-media files they are allowed to access via their supplied link. However, the cloud based system may include enough information to allow secure access back to local storage and backend servers (e.g., 644 and 642) so that a user at police station 640 may efficiently view locally stored multi-media files. That is, interact with a locally available copy of the cloud based copy pointed to by the link while maintaining audit trail information in the cloud. Alternatively, a user located remotely from police station 640 may obtain access (e.g., secure access via virtual private network (VPN)) to network and storage infrastructure at police station 640 and perform desired actions on multi-media files. That is, if required, a remote user may be redirected from the cloud to an alternative identical copy of a multi-media file while again maintaining audit trail information in the cloud. Of course, bandwidth constraints of the obtained remote access (e.g., VPN) may have an effect on what actions a remote user decides to perform.

Local hardware/software storage 644 at police station 640 may be any storage device, such as local hard drives, removable drives, network drives, and so on. As shown in FIG. 6, the SAAS functions 620 may incorporate cloud storage (630) which is not typically as limited in storage capacity as local hardware/software storage. However, remote access to large files may have associated communication bandwidth concerns. Such a SAAS content management system may limit data handling (and thus the potential for breaking the evidentiary chain of custody) because copies are not directly controlled by users.

As disclosed, a cloud-based video export and access system may reduce the hardware and ongoing maintenance costs of optical media based systems by providing users a secure, controlled, reliable and cost-effective method for sending video and data to third parties. Video and data may be uploaded to the cloud for storage, one or more third party recipients may be assigned access rights, and a defined expiration date for third party access may also be provided. Additionally, use of the cloud may permit real-time data upload and storage which provides nearly limitless data storage capacity for mobile surveillance system 100 (FIGS. 1A and 1B). Hybrid storage models may be implemented to define pre-requisites as to what actual multi-media files are stored in the cloud. For example, only multi-media files requiring access by third parties are uploaded to the cloud. Another example may be that only multi-media files that have been tagged with a particular event tag (e.g., based on event type) are uploaded to the cloud. In either or both of these examples, other multi-media files that may be less important or have not yet been fully analyzed may be maintained on local storage for future consideration. Note that even though multi-media files may be maintained on local storage, it may be desirable to upload associated metadata to the cloud based system to provide more comprehensive indexing and searching functionality across all recorded data.

Exported data may be stored in cloud-based storage that is remotely accessible through a secured means (for example, but not limited to, a password, finger print reader, etc.). As explained above in the discussion of FIGS. 5A-B, the system may be configured to send one or more recipients an access link through automated communication methods such as email, Short Messaging Service (SMS) (also referred to as text messages), and Multimedia Messaging Service (MMS), etc. The link sent to each recipient may include an expiration date for accessing the associated data. The system may also allow a recipient of the link to review the data stored in the cloud using a remote access point (e.g., 680, 682, 684) communicatively coupled through a communication channel (e.g., 681, 683, 685). The communication channel may be a VPN or simply some other communication facilitated via the Internet (e.g., encrypted HTTPS). Once a third party (remote user) obtains access to selected files on cloud storage they may also be able to download a local copy of the data for future use, and delete the data after review or download. Downloading of data may of course have negative implications as described above (see FIG. 5B) regarding “loss” of control of content. The link sent to each recipient may also limit access rights of recipients (e.g. read only, data editing, deletion, etc.) and may actually prevent downloading of data.

In order to comply with laws, court orders or record-retention policies relating to data access, the system may be configured to remove the accessible data after a predetermined expiration date. A cloud-based system thus allows users to retain the original data while limiting third party access to such data. For example, remote access point 1 (680) may allow a first group of users to access content via communication channel 681. Similarly, remote access point 2 (682) may allow additional groups of people to access content via communication channel 683. Any number of remote user groups and links may be provided for as represented by remote access point N (684) and communication channel 685. Once an access link has expired, no third party may access the expired data. The disclosed SAAS system may also provide bookkeeping functions to track content access, bandwidth usage, and subscription expiration, etc. This bookkeeping function may be capable of statistical analysis, billing, and may generate reports and invoices as needed.

FIG. 6 also graphically illustrates an example data exchange flow in block diagram 600, thorough which video, audio, and related data may be shared. Numerous users, computer-based functionalities, storage options, and associated lines of communication may be involved in data uploading and downloading. For example, one or several police vehicles 610 may transmit video and audio data and associated metadata via wireless communication means 605 to a cloud storage system 630. This wireless communication may occur, for example, while police vehicles 610 are on patrol (e.g., in transit) via a wireless communication path (e.g., satellite, cellular data, or the like). Concurrently with receipt in the cloud (or as needed), this data or a subset of this data may be made accessible to software applications, for example SAAS functions 620, via communication link 606. Police vehicle(s) 610 may also manually transfer data and metadata to local storage 644 upon arrival at police station 640 using data transmission channel 660. Data transmission channel 660 may be a wired connection or a wireless connection. In an alternative, a classical “sneakernet” may be used by connecting a portable recording device to another device (e.g., docking station 400). After connection, data may be uploaded to local storage 644, which is located at the police station, and then optionally (based on a number of different criteria, one criterion including event tags) to the cloud 630.

In the example of block diagram 600, a surveillance system vendor 670 oversees and maintains SAAS functions 620 utilizing communication channel 665. The vendor may also optionally maintain the security and integrity of any cloud based storage system 630 utilizing communication channel 666. Vendor 670 may also provide all necessary technical support through its software 620 and communication channel 645 to assist police station 640 in implementing best practices in the preservation of data evidence. Police station 640, depending on available resources, may have “in-house” routers (not shown) and surveillance system backend server(s) 642 which provide redundant data storage systems. Police station 640, in order to avoid expensive data storage solutions, may optionally utilize cloud storage 630 via communication channel 650. Cloud storage system 630 may also communicate directly with SAAS functions through communications channel 655. Having multiple channels of secured communications may provide rapid and efficient data exchange. Use of various storage means, (locally or cloud-based) allows an inexpensive and flexible alternative to resource-limited users.

As previously described, embodiments of this disclosure provide for various means of distribution for audiovisual and associated data files. For brevity, the terms “data file” and “data files” will be used to refer to audiovisual and/or associated data files. Under process flow 560, block 567 describes embodiments including a step for the determination of a method for data file delivery to identified third parties. Such embodiments provide alternatives to physical delivery of the data files. Some embodiments provide for the data files to be electronically delivered via a communication network (e.g., Internet, cloud, radio network, Bluetooth, Wi-Fi, 3G, 4G, LTE, satellite, etc.).

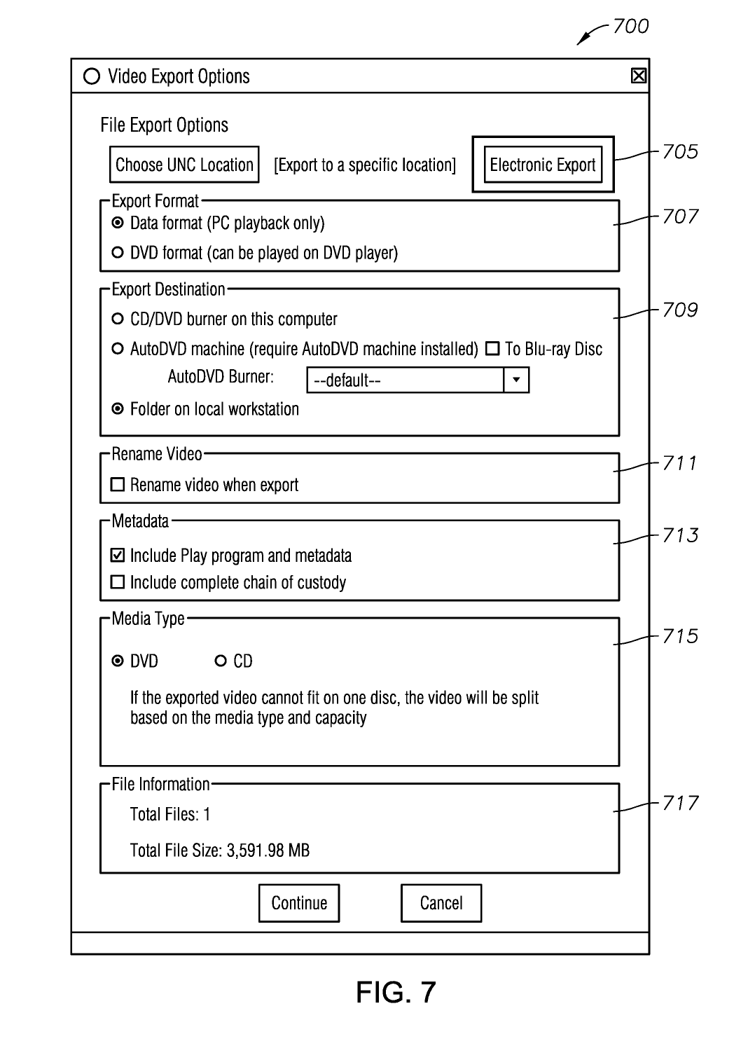

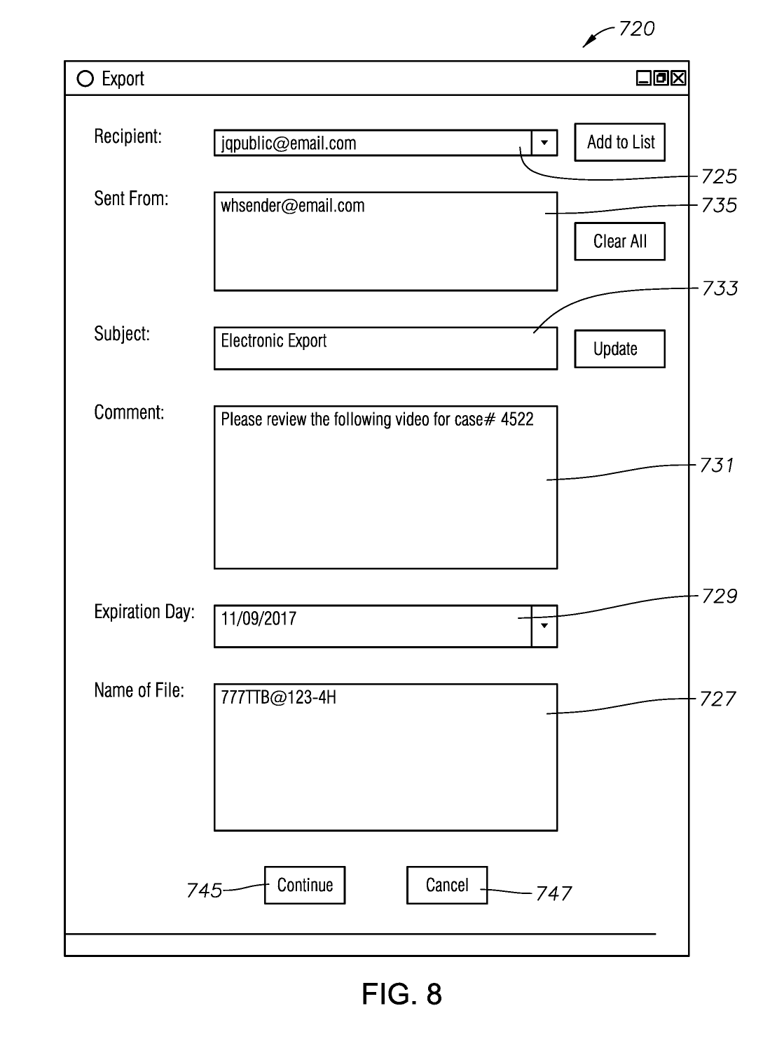

FIG. 7 illustrates an interface 700 providing a user (e.g. an administrator) export selections and setup options for data files according to some embodiments of this disclosure. The interface 700 and other forms/screens described herein may be implemented via software coded for the input device 260 controllers and may be viewed on a display (e.g. display 270). The export options include DVD production, electronic courier, and local storage (e.g. USB drive or hard drive). FIG. 7 illustrates an Electronic Export 705 option. Interface 700 may also include options to select or configure various export parameters: an Export Format selection 707 (data or DVD format); an Export Destination selection 709 (CD/DVD, AutoDVD or local folder); Video Rename selection 711 (option to rename data file at export); Metadata selection 713 (options to include metadata and/or chain of custody information); Media Type selection 715 (DVD or CD); and File Information section 717 (indicating the number of files selected for export and the total size of those files). Upon selection of the Electronic Export option 705, an export form 720 is presented. FIG. 8 illustrates an embodiment of an export form 720 as viewed on a display (e.g. display 270).

The export form 720 includes a Recipient Entry area 725 where one or more recipients are designated to receive a notice regarding designated data files. In the embodiment illustrated in FIG. 8, the export form 720 is presented with the Recipient Entry area 725 configured for user entry of a recipient's email address. The recipient entry area 725 may also include a pull-down menu listing recipients that can be selected for entry. Other modes of notification that may be implemented with embodiments of this disclosure include various messaging services such as Short Messaging Service (SMS), Multimedia Messaging Service (MMS), and other messaging methods that communicate using social media networks. The data files (e.g., audio, video, audiovisual, metadata) that are selected to be made available for export are listed in a File Name area 727. The export form 720 also includes an Expiration Date entry area 729 where a date can be entered to set an expiration date through which the designated recipient(s) will have access to the data files listed in the notice. Upon reaching the set expiration date, access to the data files is cancelled (i.e. no longer valid). Some embodiments allow for more selective access control for the data files. For example, some embodiments may be implemented wherein a user can designate on the export form 720 different access parameters for different recipients and/or different data files (e.g., recipient 1 can access data files A and B until x expiration date, recipients 2-4 can access data file B until y expiration date, recipient 5 can access data file C until z expiration date, etc.). Embodiments of the export form 720 may also include: A Comment Entry area 731 where general information may be entered (e.g., content access security requirements, type of access permitted, etc.); a Subject Entry area 733 where a note regarding the notice may be entered; and a Sender Entry area 735 where the sender's information may be entered (e.g. sender's email address).

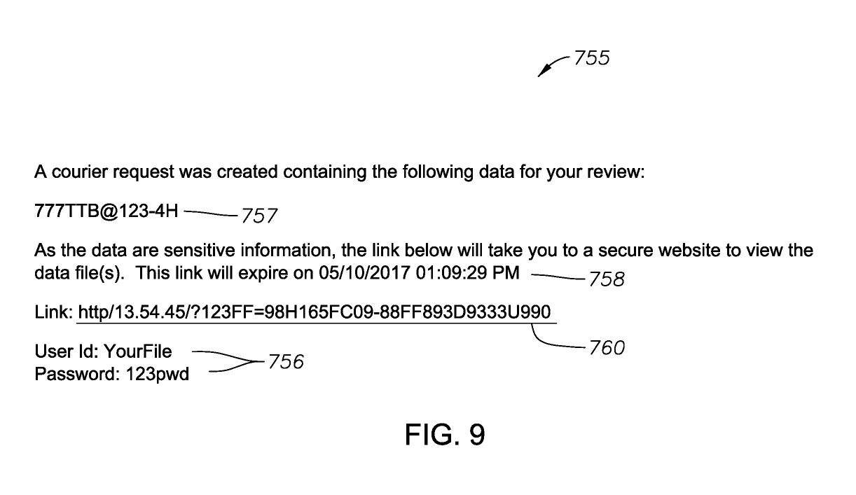

The export form 720 includes a Submit button 745 to send the notice via the communication network and a Cancel button 747 to cancel the submission process. In some embodiments, once the Submit button 745 is activated the selected data files are processed (as further described below) and the sender receives a confirmation indicating the data files have been processed/delivered. For example, some embodiments provide a pop-up window confirming that a designated data file was submitted to the cloud to be made available for access by a designated recipient(s). On the recipient side, the designated recipient(s) will receive a recipient communication indicating that the designated data files have been made available for access, downloading, and viewing, provided the recipient has the proper authorization. FIG. 9 illustrates such a recipient communication 755 received by a designated recipient via email. The recipient communication 755 contains a link 760 (e.g. hyperlink, URL, URI) pointing to a website providing login access to the designated data file(s). The login website can be hosted via any server as desired (e.g., a cloud-based virtual server, a designated agency server, etc.). The recipient communication 755 also contains information indicating the login information 756 (e.g. password, user ID), the data file names 757, and the date and time 758 on which access to the files will expire. In some embodiments, the recipient communication 755 may also contain information specific to the particular application (e.g., special security requirements such as a biometric input to access the data files or a description of the type of access available (read/view only, download, delete, etc.)).

As previously described, embodiments of this disclosure provide different options for processing, staging, and storing data files. Embodiments relating to the export and distribution of the data files to third parties also provide different options. As explained herein, data files may be uploaded to the cloud, facilitating real-time data processing and distribution. Cloud computing offers greater flexibility compared to conventional networked servers. Cloud computing offers fluctuating bandwidth portals, which facilitates real-time data transmission. For example, if data file size/quantity increases demand greater bandwidth, it is easy to scale up cloud capacity via virtual servers. Likewise, if one needs to scale down, the cloud's inherent flexibility allows for easy modification. Some embodiments may entail processing of the data files via local servers. Other embodiments may entail a hybrid system wherein some of the data files are processed via local servers and some files are uploaded to the cloud for processing. Regardless of where the data files are staged, stored, or processed, once the files are made available to a designated recipient (e.g. via recipient communication 755) the data must still be conveyed to the recipient.

It is well known in the field of computing that bandwidth defines the net bit rate, channel capacity, or the maximum throughput of a communication path in a communication network. Bit rate is a measurement of the number of bits that are transmitted over a set time period. The overall bit rate for a data file is a combination of the video stream and audio stream in the file. A simple analogy is the flow of water from a reservoir to a faucet. The water is pumped through a series of pipes linked between the reservoir and the faucet. For the data files, the audiovisual data is the water and the processing speed of computer processors represents the pump. The connection speed of the communication network (particularly the end user's connection speed) is determined by the network bandwidth, which corresponds to the diameter of the pipe. Increasing the diameter of the pipes allows for more water and more rapid flow via the pipes. Communication networks provide different bandwidth capabilities (typically established by the network provider). Regardless of the pumping power used to convey the water, there will always be a delay as the water travels through the pipes. For data files, the more data and the greater the size of the files transmitted across the network, transmission delays will vary depending on the available bandwidth. With data files, this delay increases the time it takes to convey the data bits to the end user, resulting in delayed downloads and video sputtering/freezing (e.g. when streaming a data file for playback). A way to compensate for this is to adjust the data file settings such that the overall data file bit rate is under the expected or known connection speed/bandwidth of the communication network to be used for download of the data file. By adjusting the settings or encoding the overall data file bit rate to be at or under the average connection speed (i.e. no greater than the applicable bandwidth capacity), downloading and video streaming by an end user is optimized.

Although communication network bandwidth specifications/communication speeds are disclosed by network providers, setting data file bit rates should take into account that different end users will typically have varying bandwidth/connection speed capabilities. Conventional audiovisual data encoding software provides encoding options to address such issues. One can encode a data file using variable bit rate (VBR) encoding or constant bit rate (CBR) encoding. With VBR encoding, one can set a maximum and minimum bit rate for the data file. For example, the encoding software can configure the data in the data file for transmission at a set minimum bit rate when there is little to no motion in the image and at a set maximum bit rate when there is frequent motion. This streamlines transmission of the data file across the communication network. However, care should be taken to avoid encoding at a maximum bit rate that exceeds the end user's bandwidth/connection speed. The data files may use CBR encoding when a flat bit rate will suffice for transmission across the applicable communication network.

Some embodiments of this disclosure entail processing of data files to convert such files to generate modified versions thereof to facilitate transmission across networks with bandwidth/connection speed limitations or restrictions. Such embodiments include making adjustments to the data file settings (e.g., compression, bit rate, quality, resolution, etc.). As well known by those skilled in the art, video resolution is determined by the number of lines and pixels set in formatting the video data. The greater the number of lines/pixels (i.e. higher resolution) used in formatting the video, the sharper the image quality. Embodiments of this disclosure may be implemented wherein one or more of the data file settings are adjusted during conversion of the file to generate a modified version with a different setting or settings compared to the setting(s) of the original data file. For example, adjustments can be made to the data file settings such as: resolution, bit rate, quality, compression, or a combination of these settings. Some embodiments entail conversion of a data file to generate a version with a lower resolution and/or a lower bit rate compared to those settings of the original file. Some embodiments entail conversion of a data file to generate a version with a higher data compression setting compared to the setting of the original file. Embodiments using data compression may entail lossy or lossless compression techniques as known in the art. Conventional software and encoding methods may be used to convert the data files to generate modified versions of the original data files. For example, but not by way of limitation, the data files may be converted using the H.264 or MPEG-4 Part 10, Advanced Video Coding (MPEG-4 AVC) video standard, the H.265 and MPEG-H Part 2, High Efficiency Video Coding (HEVC) standard, the VP9 video coding format developed by Google®, or subsequently developed standards and formats.

Some embodiments may be implemented by encoding the data files using fixed or constant bit rates in the conversion of the data files. That is, the user or a software algorithm can select and cause a data file to be encoded using a constant bit rate for conversion of the data file, generating a modified version of the original data file. Some embodiments provide options for use of variable bit rates, allowing one to mix and match bit rates in the conversion of the data files. That is, the user or a software algorithm can select and cause a data file to be encoded using different bit rates, e.g., using an established range of bit rates, for conversion and generation of a modified version of the original data file. Some embodiments are implemented for generation of the modified data file version using a variable bit rate with a set maximum bit rate limit or ceiling. The user or a software algorithm can select different bit rates to be applied for conversion of different individual files, different types of files, different groups of files (e.g., a group of files may be defined by the time of creation of the files, by being associated with one or more given recipient(s), by being associated with one or more given events or event types, etc.), or according to the available bandwidth/connection speed capacity. Some embodiments may also be implemented wherein a combination of data file settings (e.g. compression and resolution) are adjusted to generate the modified version of the data file. The ability to configure and adjust the data file settings provides greater flexibility to optimize the transfer and streaming of data files to the designated recipient(s).

In some embodiments, once a data file is designated for electronic export (e.g. via export form 720) it is then converted to generate the modified version. The original data file may be modified by adjusting one or more of the file's settings: bit rate, compression, quality, resolution, etc. The modified data file, with adjusted file settings, can be transmitted using less bandwidth compared to the bandwidth capacity required by the original (unmodified) data file. The modified data file is then placed in a staging area, along with the original data file. The staging area may be a local server, a cloud-based virtual server, or a hybrid combination of remote/local servers and cloud-based servers. In some embodiments, associated data files (e.g., containing metadata such as officer ID, bookmarks, etc.) may also be staged for download and viewing along with the original and/or modified data files, or separately in a cloud-based, local, or remote database. Each designated recipient is sent a notice via the communication network, indicating that the designated data files have been made available for access and viewing. The designated recipient can then access and view and download the original and/or the modified version of the data file. Having the option to download the modified data file allows recipients with bandwidth/connection speed limitations to access and view the data files made available.

In some embodiments, the original data file is uploaded or staged in a holding area (e.g., to a cloud-based server, local/remote server, or hybrid network) and the file is not converted to generate a modified version thereof (e.g. with higher compression and/or reduced bit rate) until the designated recipient accesses the file. For example, in some embodiments, once an administrator enters a data file for export in the File Name area 727 of the export form 720, the original data file may be staged in cloud storage and conversion of the data file to generate a modified version thereof will not occur until the designated recipient triggers access to view the file. When the designated recipient triggers access (e.g. by login via link 760), the original data file is converted to generate the modified version while the original data file is queued from the storage location and staged for access by the recipient (on the fly). The modified version of the data file is also made available for access by the recipient. This provides more efficient use of computing resources.

Once a designated recipient receives notification of the available access to the data files, he will have access to the files (e.g. via link 760) until the expiration date stated in the notice. The recipient can then log in and access either one or both of the data files (i.e. original data file and/or converted data file) as desired. Some embodiments provide secure methods for downloading and streaming the data files (e.g., using network protocols such as HTTPS, SFTP, etc.). Conventional data encryption techniques may also be used with embodiments of this disclosure (e.g., AES 256 or higher, SSH protocols, digital watermarking, cryptographic hash functions, etc.). In some embodiments, data uploaded to the cloud is remotely accessible through secured means (e.g., using passwords, biometric data readers, encryption, etc.), allowing a recipient to review the data stored in the cloud using a remote access point (e.g. 680, 682, 684, FIG. 6) communicatively coupled through the communication network (e.g. communication channel 681, 683, 685, FIG. 6). The communication channel may also be a VPN or some other communication facilitated via the Internet (e.g., encrypted HTTPS). Once a designated recipient obtains access to the data files, he may download a local copy of the data for future use and deletion after review, provided the recipient has the proper authorization.

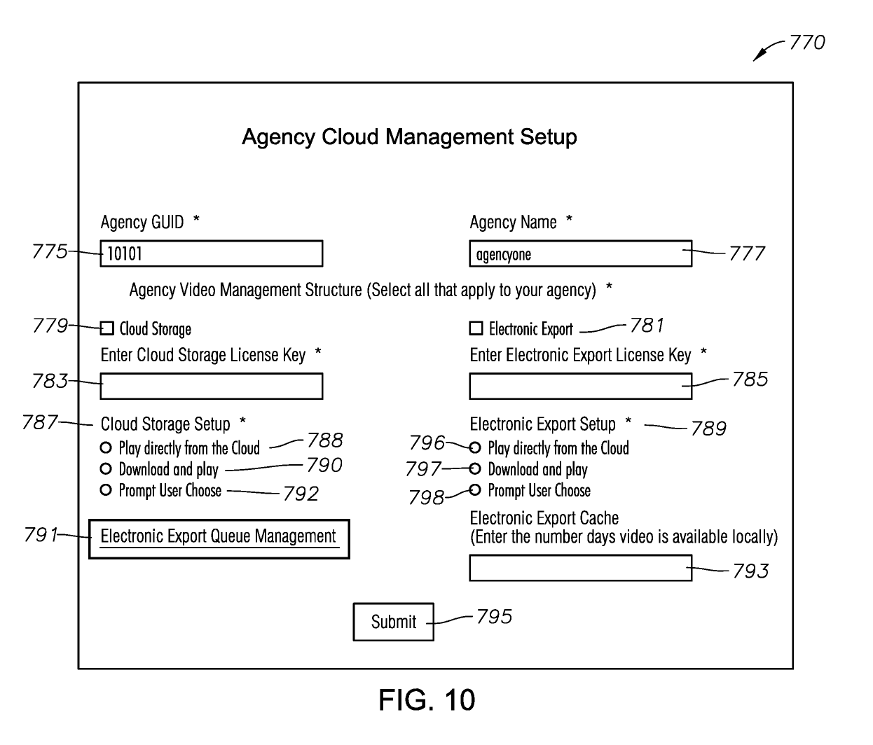

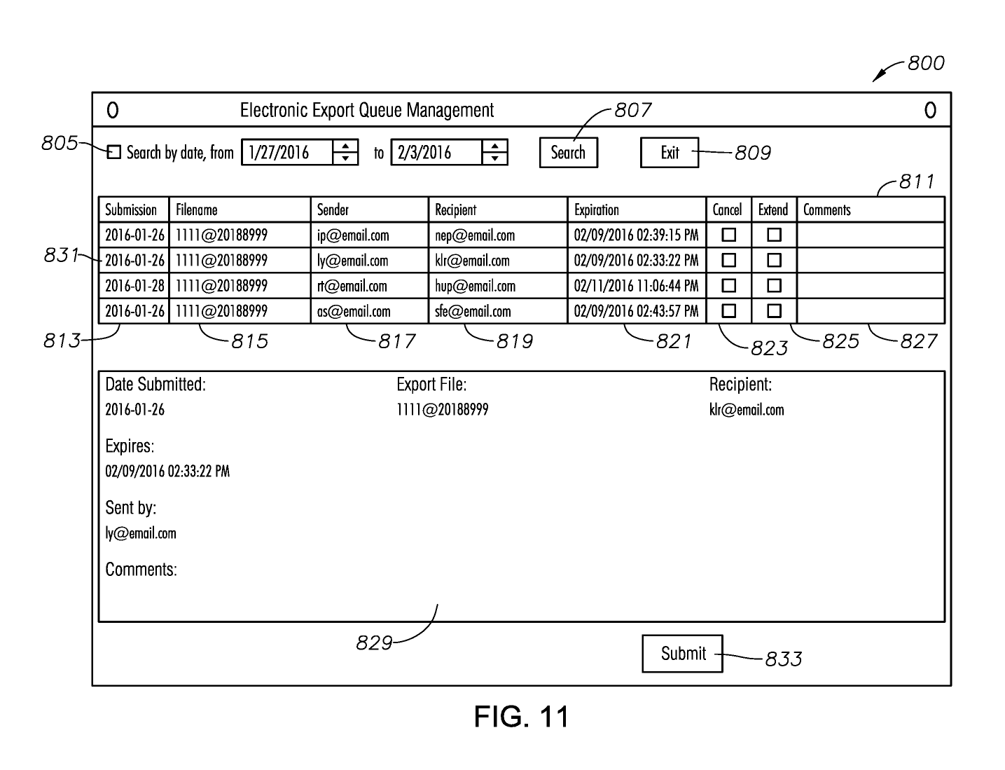

Some embodiments of this disclosure include options for ongoing management of the data files and information made available to designated recipients. For example, some embodiments allow an administrator to make changes to the data files previously made available to designated recipients and to the expiration date by which a recipient can access the respective data file(s). In some embodiments, an administrator can: extend or shorten the access expiration date and time; cancel/modify access by individual designated recipients; add or remove designated recipients; add or remove data files; and/or edit information previously provided to recipients. FIG. 10 illustrates a Management Setup form 770 that may be used by an administrator to set up the data file structure for a particular agency or organization and to manage the data files. Embodiments of the Management Setup form 770 may include various fields for the administrator to enter pertinent information and configuration/option selections: an Agency Globally Unique Identifier (GUID) entry area 775; an Agency Name entry area 777; a Cloud Storage designator 779; an Electronic Export designator 781; a Cloud Storage License Key entry area 783; an Electronic Export License Key area 785; a Cloud Storage Setup area 787 (permitting selection of the options: play from the cloud 788, download and play 790, or prompt user choice 792); an Electronic Export setup area 789 (permitting selection of the options: play from the cloud 796, download and play 797, or prompt user choice 798), an Electronic Export Queue Management option 791 (described below with reference to FIG. 11); and an Electronic Export Cache designator 793 (number of days data file(s) is available locally). An administrator can log the data in Management Setup form 770 to a database server via Submit button 795.

Upon selection of the Electronic Export Queue Management option 791 on Management Setup form 770, a Queue Management screen 800 is presented. FIG. 11 illustrates an embodiment of a Queue Management screen 800 as viewed on a display (e.g. display 270). The screen 800 includes a File Search by date option 805 (providing file searches between a range of dates); a Search activation button 807; a screen Exit button 809; and a Data File Information area 811. The Data File Information area 811 lists the data file records in the database with submission dates within the date range set in File Search area 805. The Data File Information area 811 may include: a Submission area 813 (listing the data file submission date); a Filename area 815; a Sender area 817; a Recipient area 819; an Expiration date area 821 (listing the respective file expiration date entered in expiration date entry area 729 of export form 720); a Cancel option 823 (to cancel access to the respective data file); an Extend option 825 (to extend the recipient access period to the respective data file by altering the expiration date in Expiration date area 821); and a Comment area 827. Embodiments of Queue Management screen 800 may also include a Data File Summary area 829, displaying a summary of a respective data file record highlighted by the administrator (e.g. data file record 831 in Data File Information area 811). The Data File Summary area 829 in FIG. 11 lists the data file submission date, filename, recipient, sender, expiration date, and comments. An administrator can update and log the data in Queue Management screen 800 to a database server via Submit button 833.

It will be appreciated by those skilled in the art that the processing and handling of the data files for export and distribution can be performed using conventional computer platforms entailing processors configured with conventional software coded to perform the disclosed techniques. For example, but not by way of limitation, platforms such as Microsoft® Cloud services may be used to implement embodiments of this disclosure. It will also be appreciated that any suitable device may be used to implement the embodiments of this disclosure. For example, embodiments may be implemented for operation with a smartphone or a tablet device. As previously described, embodiments may be implemented wherein the recipient notification (which notifies the recipient of available data files, access link, access expiration date, etc.) is transmitted by conventional means such as email, messaging services such as Short Messaging Service and Multimedia Messaging Service, and/or other messaging methods that communicate using social media networks. Some embodiments may be implemented using a mobile device equipped with an application (“app”) configured to perform the disclosed techniques (e.g. a COBAN app offered by COBAN Technologies, Inc., in Houston, Tex. (http//www.cobantech.com)). Such embodiments allow for convenient direct upload and viewing of desired data files by users on the go.

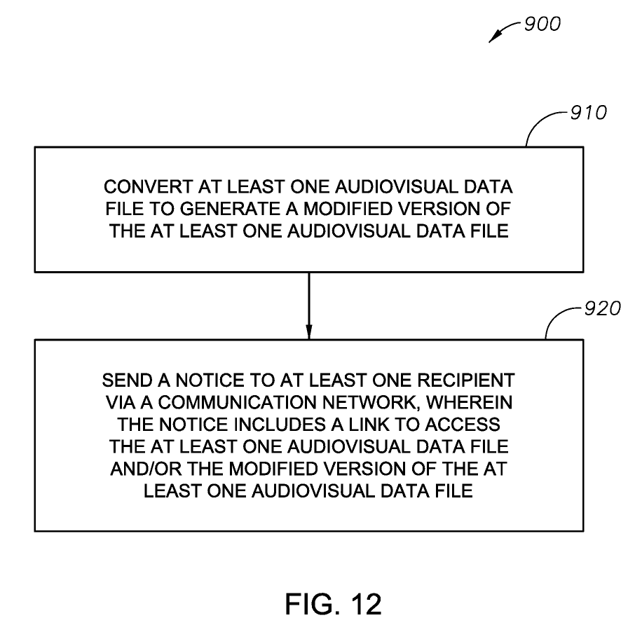

FIG. 12 is a flow chart depicting a method 900 according to an embodiment of this disclosure. At step 910, at least one audiovisual data file is converted to generate a modified version of the at least one audiovisual data file. At step 920, a notice is sent to at least one recipient via a communication network, wherein the notice includes a link to access the at least one audiovisual data file and/or the modified version of the at least one audiovisual data file. This method may be implemented using the techniques and embodiments disclosed herein.

In light of the principles and example embodiments described and illustrated herein, it will be recognized that the example embodiments may be modified in arrangement and detail without departing from such principles. Also, the foregoing discussion has focused on particular embodiments, but other configurations are also contemplated. In particular, even though expressions such as “in one embodiment,” “in another embodiment,” or the like are used herein, these phrases are meant to generally reference embodiment possibilities, and are not intended to limit the invention to particular embodiment configurations. As used herein, these terms may reference the same or different embodiments that are combinable into other embodiments. As a rule, any embodiment referenced herein is freely combinable with any one or more of the other embodiments referenced herein, and any number of features of different embodiments are combinable with one another, unless indicated otherwise.

Similarly, although example processes have been described with regard to particular operations performed in a particular sequence, numerous modifications might be applied to those processes to derive numerous alternative embodiments of the present invention. For example, alternative embodiments may include processes that use fewer than all of the disclosed operations, processes that use additional operations, and processes in which the individual operations disclosed herein are combined, subdivided, rearranged, or otherwise altered.

This disclosure may include descriptions of various benefits and advantages that may be provided by various embodiments. One, some, all, or different benefits or advantages may be provided by different embodiments. In view of the wide variety of useful permutations that may be readily derived from the example embodiments described herein, this detailed description is intended to be illustrative only, and should not be taken as limiting the scope of the invention. What is claimed as the invention, therefore, are all implementations that come within the scope of the following claims, and all equivalents to such implementations.

1. A method, comprising:
converting at least one audiovisual data file to generate a modified version of the at least one audiovisual data file; and
sending a notice to at least one recipient via a communication network, wherein the notice includes a link to access the at least one audiovisual data file and/or the modified version of the at least one audiovisual data file.

2. The method of claim 1, wherein the sending a notice comprises sending the notice via at least one of: (i) an email, (ii) a Short Messaging Service (SMS), (iii) a Multimedia Messaging Service (MMS), and (iv) other messaging methods that communicate using social media networks.

3. The method of claim 1, wherein the converting the at least one audiovisual data file comprises creating a modified version of the at least one audiovisual data file that can be transmitted using less bandwidth compared to the bandwidth capacity required by the at least one audiovisual data file.

4. The method of claim 1, wherein the converting the at least one audiovisual data file comprises generating a modified version of the at least one audiovisual data file encoded using a constant bit rate.

5. The method of claim 1, wherein the converting the at least one audiovisual data file comprises generating a modified version of the at least one audiovisual data file encoded using a variable bit rate with a set maximum bit rate.

6. The method of claim 1, further comprising setting an expiration date for the at least one recipient to access the at least one audiovisual data file.

7. The method of claim 6, wherein the notice sent to the at least one recipient includes the set expiration date.

8. The method of claim 1, further comprising storing one or more metadata files containing attributes of the at least one audiovisual data file.

9. The method of claim 1, further comprising storing the at least one audiovisual data file and/or the modified version of the at least one audiovisual data file.

10. The method of claim 1, wherein the at least one audiovisual data file and/or the modified version of the at least one audiovisual data file are/is uploaded to the cloud.

11. The method of claim 1, wherein the conversion of the at least one audiovisual data file to generate the modified version of the at least one audiovisual data file is performed upon activation of the link by the at least one recipient.

12. The method of claim 1, wherein the modified version of the at least one audiovisual data file differs from the at least one audiovisual data file in respect of a bit rate setting thereof.

13. The method of claim 1, wherein the modified version of the at least one audiovisual data file differs from the at least one audiovisual data file in respect of a resolution setting thereof.

14. The method of claim 1, wherein the modified version of the at least one audiovisual data file differs from the at least one audiovisual data file in respect of a data compression setting thereof.

15. The method of claim 1, wherein the modified version of the at least one audiovisual data file differs from the at least one audiovisual data file in respect of one or more file settings thereof.

16. A system, comprising:
one or more processors configured to execute instructions to cause the one or more processors to:
convert at least one audiovisual data file to generate a modified version of the at least one audiovisual data file; and
send at least one recipient a notice via a communication network,
wherein the notice includes a link to access the at least one audiovisual data file and/or the modified version of the at least one audiovisual data file.

17. The system of claim 16, wherein the notice is sent via at least one of: (i) an email, (ii) a Short Messaging Service (SMS), (iii) a Multimedia Messaging Service (MMS), and (iv) other messaging methods that communicate using social media networks.

18. The system of claim 16, wherein the one or more processors are configured to convert the at least one audiovisual data file to generate a modified version of the at least one audiovisual data file that can be transmitted using less bandwidth compared to the bandwidth capacity required by the at least one audiovisual data file.

19. The system of claim 16, wherein the modified version of the at least one audiovisual data file is encoded using a constant bit rate.

20. The system of claim 16, wherein the modified version of the at least one audiovisual data file is encoded using a variable bit rate with a set maximum bit rate.

21. The system of claim 16, wherein the notice includes an expiration date for the at least one recipient to access the at least one audiovisual data file.

22. The system of claim 16, wherein the one or more processors are configured to store one or more metadata files containing attributes of the at least one audiovisual data file.

23. The system of claim 16, wherein the one or more processors are configured to store the at least one audiovisual data file and/or the modified version of the at least one audiovisual data file.

24. The system of claim 16, wherein the one or more processors are configured to upload the at least one audiovisual data file and/or the modified version of the at least one audiovisual data file to the cloud.

25. The system of claim 16, wherein the one or more processors are configured to convert the at least one audiovisual data file to generate the modified version of the at least one audiovisual data file upon activation of the link by the at least one recipient.

26. The system of claim 16, wherein the modified version of the at least one audiovisual data file differs from the at least one audiovisual data file in respect of a bit rate setting thereof.

27. The system of claim 16, wherein the modified version of the at least one audiovisual data file differs from the at least one audiovisual data file in respect of a resolution setting thereof.

28. The system of claim 16, wherein the modified version of the at least one audiovisual data file differs from the at least one audiovisual data file in respect of a data compression setting thereof.

29. The system of claim 16, wherein the modified version of the at least one audiovisual data file differs from the at least one audiovisual data file in respect of one or more file settings thereof.
